(19) United States
(12) Patent Application Publication
(10) Pub. No.: US 2022/0227166 A1
(43) Pub. Date: Jul. 21, 2022

(54) AERODYNAMIC TRUCK WHEEL COVER

(71) Applicant: SABBA ANTHONY TORTU, NAPLES, FL (US)

(72) Inventor: SABBA ANTHONY TORTU, NAPLES, FL (US)

(21) Appl. No.: 17/153,408

(22) Filed: Jan. 20, 2021

(51) Int. Cl. B60B 7/02; B60B 7/06; B60B 7/10

(52) U.S. Cl. CPC B60B 7/02; B60B 2900/1216; B60B 7/10; B60B 7/061

(57) ABSTRACT

An aerodynamic disk-shaped wheel cover (1) having a central aperture (3) and at least two pair of attachment slots (6) about a periphery of said cover. A method of attaching the cover to a wheel is provided by ties (7) through the slots is provided. The wheel cover is size adjustable to fit varying sizes of wheels by providing a slit (4) extending from a periphery of the central aperture to a circumference (9) of the cover.

### FIELD OF THE INVENTION

This invention relates to wheel covers and more particularly to an aerodynamic truck wheel cover that is adjustable in size to fit different size wheels.

### BACKGROUND OF THE INVENTION

Trucks, particularly tractor trailers, consume large amounts of fuel especially when carrying full loads. Thus, operators of such trucks are always seeking ways to save fuel by reducing aerodynamic drag. This is accomplished primarily through rounding of the front surfaces, the use of roof and side deflectors and the use of fairings over the fuel tanks between the steering axle and the drive axles. However, another large source of drag which is often ignored are the truck wheels, namely the six wheels facing outward on a tractor and four wheels facing outward on the trailer for a total of ten outwardly facing wheels.

Another complicating factor in attempting to reduce drag caused by tractor trailer wheels is that not all wheels are the same size. There are two types of tractor trailer wheels, steel and aluminum. Although aluminum wheels are the same size, the more common steel wheels vary in size.

Current wheel covers for reducing aerodynamic drag are expensive and require tools to install. Furthermore, such wheel covers fit only aluminum wheels which do not vary in size as do steel wheels, the more common wheels on tractor trailers.

In view of the above problems, a need exists for a wheel cover for a truck that reduces aerodynamic drag which is inexpensive, easy and quick to install and that is adjustable in size to fit all sizes of truck wheels.

### SUMMARY OF THE INVENTION

The primary object of the present invention is to provide a truck wheel cover that reduces aerodynamic drag.

Another object of the present invention is to provide such a truck wheel cover that is easy and quick to install.

An additional object of the present invention is to provide such a wheel cover does not require tools to install.

An even further object of the present invention is to provide such a wheel cover that is adjustable in size to fit varying sizes and types of truck wheels.

The present invention accomplishes the above and other objects by providing a wheel cover comprising a circular disk having a central aperture with a slit extending radially from proximate a periphery of the central aperture to a circumference of the disk and at least two pair of slots proximate a periphery of the disk. The wheel cover can be attached to the wheel by inserting at least two ties through one of the at least two pair of slots around a spoke of the wheel and twisting the ties. The wheel cover may also have a slot proximate the central aperture for inserting an attachment tie, The wheel cover would preferably be manufactured in a standard most common size of truck wheel and have a bridge piece connecting the slit at the circumference. Then, as necessary the wheel cover can be adjusted in size to fit a particular wheel removing the connecting bridge in the disk and expanding or decreasing the size of the slit to alter the circumference of the cover to accommodate the wheel of a vehicle.

The above and other objects, features and advantages of the present invention should become even more readily apparent to those skilled in the art upon a reading of the following detailed description in conjunction with the drawings wherein there is shown and described illustrative embodiments of the invention.

### DESCRIPTION OF THE DRAWINGS

In the following detailed description, reference will be made to the attached drawings in which:

FIG. 1 is a perspective view of truck wheel cover of the present invention installed on a truck wheel;

FIG. 2 is an exploded side view of the truck wheel cover of the present invention prior to installation on a truck wheel;

FIG. 3 is a front view of the truck wheel cover of the present invention in a fixed-size mode; and

FIG. 4 is a front view of the truck wheel cover of the present invention in an adjustable-size mode.

### DESCRIPTION OF THE PERFERRED EMBODIMENTS

For purposes of describing the preferred embodiment, the terminology used in reference to the numbered accessories in the drawings is as follows:
1. aerodynamic wheel cover, generally
2. tire
3. central aperture
4. size adjustment slit
5. central attachment slot
6. outer attachment slots
7. attachment ties
8. wheel
9. wheel cover circumference
10. size adjustment slit bridge

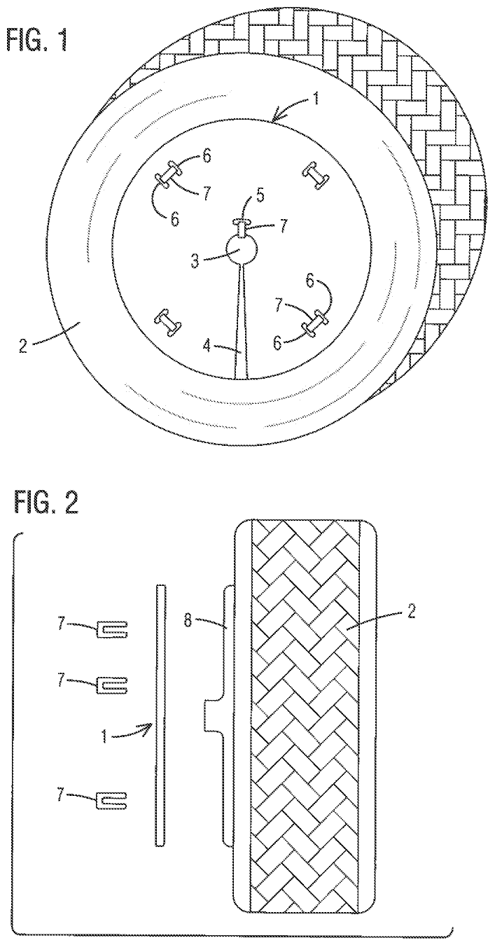

Discussing the preferred embodiments of the wheel cover of the present invention, reference is made to the drawings. FIGS. 1 and 2 illustrate the wheel cover 1 in perspective view attached to a truck wheel 8 and tire 2. The cover 1 has a central aperture 3 to accommodate a central extension of a hub cap of a wheel 8 and to provide for easy removal of the wheel cover 1 without the need for tools. The wheel cover 1 has at least two pairs of slots 6 proximate a periphery to allow for attachment to a wheel 8 by inserting ties 7 around spokes of a wheel 8 and the slots 6 and twisted to secure the cover 1 to a wheel. A slit 4 is provided which extends from proximate a periphery of the central aperture to a circumference of the cover. Thusly, the size of the wheel cover can be increased or decreased to fit varying size of wheels, whether aluminum or steel wheels, by closing the slit or overlapping sides of the slit to decrease a size of the cover or, alternatively, increasing a size of the wheel cover 1 by spreading the slit to increase the size of the wheel cover.

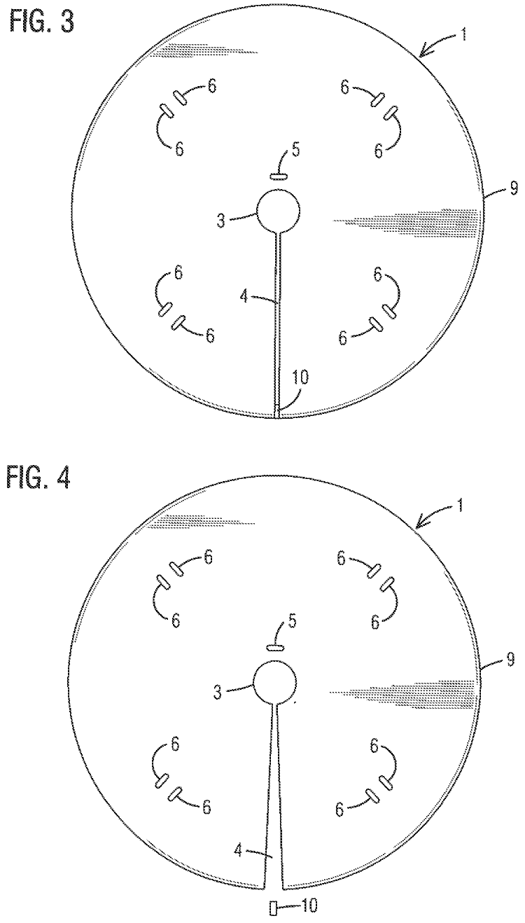

FIGS. 3 and 4 illustrate a fixed-size wheel cover and an adjustable-size wheel cover, respectively. As illustrated in FIG. 3 the cover would be manufactured with a connecting bridge 10 in a peripheral end of the slit on a circumference 9 of the wheel cover. Then to make the cover adjustable the connecting bridge 10 is removed as illustrated in FIG. 4, thereby allowing the cover 1 to be increased in size by opening or spreading the slit 4 or decreased in size by closing the slit 4, even overlapping sides of the slit 4.

The wheel cover 1 would preferably be made of a flexible plastic so it would be lightweight and easily adjustable in size. Employing the wheel cover of this invention on a truck provides aerodynamic benefits by significantly reducing drag caused by tire wheels, particularly for tractor trailers trucks that have many wheels. The reduction in drag saves fuel and reduces fuel expenditures of truck drivers, ultimately reducing shipping costs to the consumer.

It is to be understood that while a preferred embodiment of the invention is described, it is not to be limited to the specific form or arrangement of parts herein described and shown. It will be apparent to those skilled in the art that various changes may be made without departing from the scope of the invention and the invention is not to be considered limited to what is shown and described in the specification and/or drawings.

Having thus described my invention, I claim:

1. A wheel cover comprising:
a circular disk having a central aperture and a circumference of sufficient size to cover a wheel;
a slit extending radially from proximate a periphery of the central aperture to a circumference of the disk; and
at least two pair of slots proximate a periphery of the disk.

2. The wheel cover of claim 1 further comprising at least two ties for attaching the wheel cover to a wheel by inserting each of said two ties through one of the at least two pair of slots and to the wheel.

3. The wheel cover of claim 1 further comprising a slot proximate the central aperture for inserting an attachment tie.

4. The wheel cover of claim 1 further comprising a connecting bridge in the slit, said bridge being located in a distal end of said slit proximate the circumference of the disk.

5. A method of making a wheel cover adjustable in size, said wheel cover having a circular disk having a central aperture and a circumference of sufficient size to cover a wheel, a slit extending radially from proximate a periphery of the central aperture to a circumference of the disk and at least two pair of slots proximate a periphery of the disk, said method comprising:
increasing or decreasing the size of the slit to alter the circumference of the cover to accommodate the wheel of a vehicle.

6. The wheel cover of claim 1 further comprising a connecting bridge in the slit proximate the circumference of the cover.

7. A method of making a wheel cover adjustable in size, said wheel cover having a circular disk having a central aperture and a circumference of sufficient size to cover a wheel, a slit extending radially from proximate a periphery of the central aperture to a circumference of the disk, at least two pair of slots proximate a periphery of the disk and a connecting bridge in the slit proximate the circumference of the cover, said method comprising the steps of:
removing the connecting bridge in the slit; and
increasing decreasing the size of the slit to alter the circumference of the cover to accommodate the wheel of a vehicle.
